(19) United States
(12) Patent Application Publication
(10) Pub. No.: US 2013/0255388 A1
(43) Pub. Date: Oct. 3, 2013

(54) PROBE AND OBJECT INFORMATION ACQUISITION APPARATUS USING THE SAME

(71) Applicant: CANON KABUSHIKI KAISHA, Tokyo (JP)

(72) Inventors: Eiji Takeuchi, Yokohama-shi (JP); Koichiro Nakanishi, Tokyo (JP)

(73) Assignee: CANON KABUSHIKI KAISHA, Tokyo (JP)

(21) Appl. No.: 13/795,523

(22) Filed: Mar. 12, 2013

(30) Foreign Application Priority Data
Mar. 31, 2012 (JP) 2012-083419
Feb. 28, 2013 (JP) 2013-040133

(51) Int. Cl. G01N 29/24

(52) U.S. Cl. CPC G01N 29/2418
USPC 73/655

(57) ABSTRACT

A probe is provided that can suppress the warp of an optical reflection member on a receiving surface and stably receive photoacoustic waves. The probe includes: an element having at least one cell in which a vibration film containing one electrode out of two electrodes that are provided so as to interpose a space therebetween is supported in a manner allowed to vibrate owing to the acoustic wave; an optical reflection layer 108 that is provided closer to the object than the element is; a support layer 104 supporting the optical reflection layer 108; and a warp suppressing layer 106 that is provided on at least one of the both surfaces of the support layer 104.

### BACKGROUND OF THE INVENTION

1. Field of the Invention

The present invention relates to a probe that is used as a photoacoustic probe and includes a capacitive electromechanical transducer having an optical reflection member, and an object information acquisition apparatus using the same.

2. Description of the Related Art

Conventionally, micro-machine components manufactured by micromachining technologies can be processed in a micrometer order. Use of these components has realized various micro-functional elements. Capacitive electromechanical transducers using these technologies have been studied as alternatives to electromechanical transducers adopting piezoelectric elements. Such a capacitive electromechanical transducer can transmit and receive acoustic waves, such as ultrasonic wave, (hereinafter, may be typified as “ultrasound”) through use of a vibration film. Particularly, in liquid, excellent wide-band characteristics can be easily acquired. In this specification, the acoustic waves are any of sound waves, ultrasonic wave, and photoacoustic waves. For instance, the photoacoustic waves are caused by irradiating the inside of an object with light (electromagnetic waves), such as visible or infrared light.

Meanwhile, there is a capacitive micromachined ultrasonic transducer that irradiates a measurement target (object) with illumination light and receives photoacoustic waves emitted from the inside of the object (Japanese Patent Application Laid-Open No. 2010-075681). This transducer includes an optical reflection member for reflecting light. The optical reflection member is disposed on a receiving surface for receiving photoacoustic waves. The optical reflection member has a configuration of covering the entire receiving surface. Furthermore, there is a capacitive micromachined ultrasonic transducer including a protection film (Japanese Patent Application Laid-Open No. 2009-272824). This transducer has a configuration including the protection film on an upper electrode. The protection film may be made of insulating organic material.

### SUMMARY OF THE INVENTION

The capacitive micromachined ultrasonic transducer receiving photoacoustic waves can suitably include the optical reflection member. The optical reflection member includes a support layer and a reflection layer. However, formation of the reflection layer on the support layer sometimes warps the optical reflection member. A resin film is employed as the support layer; a suitable film has an acoustic impedance close to that of an object. The acoustic impedance is defined as the product between a density and a sonic velocity. Instead, the acoustic impedance can be represented using a modulus of volume elasticity, a stiffness modulus and a density. The resin film having an acoustic impedance close to that of the object tends to have a low density and a low stiffness. Accordingly, formation of a metal film, which is to be the reflection layer, on the support layer sometimes warps the support layer. The warp of the support layer may exfoliate the optical reflection member. In particular, in the case where an acoustic impedance matching layer is provided between the support layer and the element, the adhesive property between the acoustic impedance matching layer and the support layer is insufficient. Accordingly, there is a possibility that the optical reflection member exfoliates.

To solve the problem, the present invention has an object to provide a probe that includes an optical reflection member having low warp.

A probe of the present invention to solve the problem is a probe receiving an acoustic wave from an object, including: an element having at least one cell in which a vibration film containing one electrode out of two electrodes that are provided so as to interpose a space therebetween is supported in a manner allowed to vibrate owing to the acoustic wave; an optical reflection layer that is provided closer to the object than the element is; a support layer that is provided closer to the element than the optical reflection layer is, and supports the optical reflection layer; and a warp suppressing layer to suppress the warp of the support layer, that is provided on at least one of a surface of the support layer closer to the optical reflection layer and a surface of the support layer closer to the element.

Further features of the present invention will become apparent from the following description of exemplary embodiments with reference to the attached drawings.

### BRIEF DESCRIPTION OF THE DRAWINGS

FIG. 1 is a sectional view of an example of a photoacoustic probe of the present invention.

FIG. 2 is sectional view illustrating a photoacoustic probe of Example 1 of the present invention.

FIG. 3 is a sectional view illustrating a photoacoustic probe of Example 2 of the present invention.

FIG. 4A is a top plan view of the probe. FIG. 4B is a sectional view of a probe using a capacitive electromechanical transducer (sacrificial layer type) taken along line 4B-4B.

FIG. 5 is a sectional view of a probe using a capacitive electromechanical transducer (bonding type).

FIG. 6 is a diagram schematically illustrating the photoacoustic probe of the present invention.

FIG. 7 is a diagram illustrating an object information acquisition apparatus using the probe of the present invention.

### DESCRIPTION OF THE EMBODIMENTS

Preferred embodiments of the present invention will now be described in detail in accordance with the accompanying drawings.

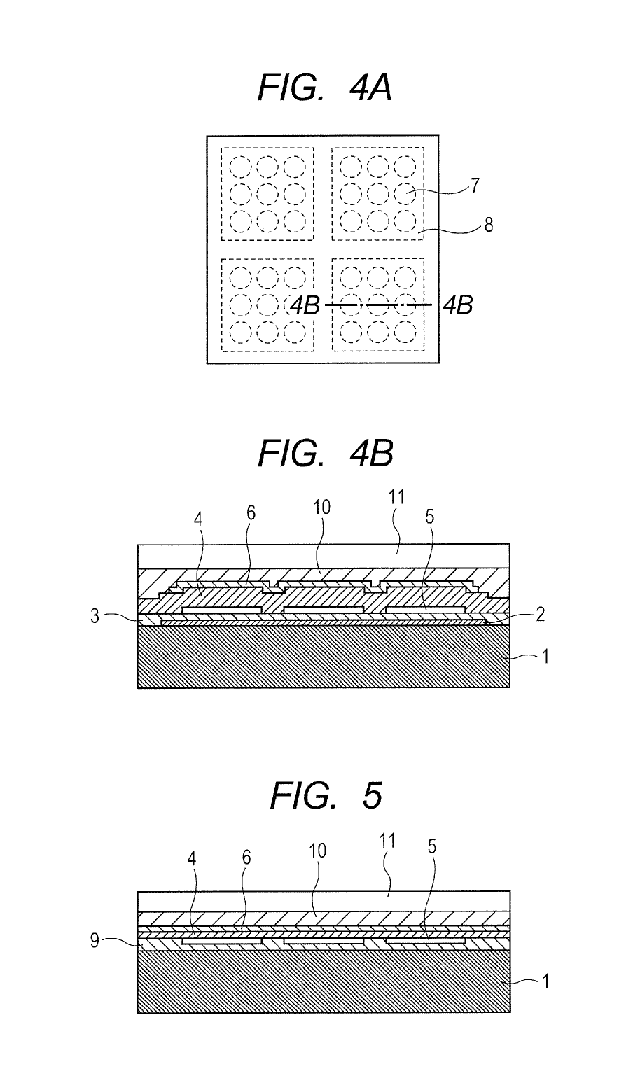

A probe of this embodiment includes a capacitive electromechanical transducer as a detection unit of receiving acoustic waves from an object. An optical reflection member provided on the vibration film (i.e., on a side that is closer to the object than the element is) includes a warp suppressing layer provided on at least one of surfaces of a support layer made of resin and an optical reflection layer and both surfaces of the support layer. In this configuration, the support layer has a sufficiently high acoustic wave transparency, and the optical reflection layer of the optical reflection member that is for reflecting irradiation light on an object and scattered light thereof has a sufficiently high optical reflectivity. The warp suppressing layer has a sufficiently high acoustic wave transparency and an appropriate hardness (Young's modulus), and can be provided at a position suppressing the warp of the optical reflection member (particularly, the support layer) owing to the stiffness. To suppress the warp, for instance, a thin film that is made of hard material, i.e., inorganic material, such as SiO₂, and provided on at least one of both the surfaces of the support layer can be employed. For instance, a cell of the electromechanical transducer includes: a second electrode formed, via a space, on a first electrode formed in contact with a substrate; a vibration film on which the second electrode is provided; and a vibration film supporter that supports the vibration film such that a space is formed between the first electrode and the vibration film. The cell can be fabricated according to a method of manufacturing any of types called a sacrificial layer type and a bonding type. An example of FIGS. 4A and 4B, which will be described later, includes a structure that can be fabricated according to the method of manufacturing a sacrificial layer type. An example of FIG. 5, which will be described later, includes a structure that can be fabricated according to the method of manufacturing the bonding type. The probe of this embodiment, a light source and a data processing device can configure an object information acquisition apparatus. Here, the probe receives acoustic waves caused by irradiation of an object with light emitted from the light source, converts the waves into an electric signal. The data processing device acquires information on the object using the electric signal.

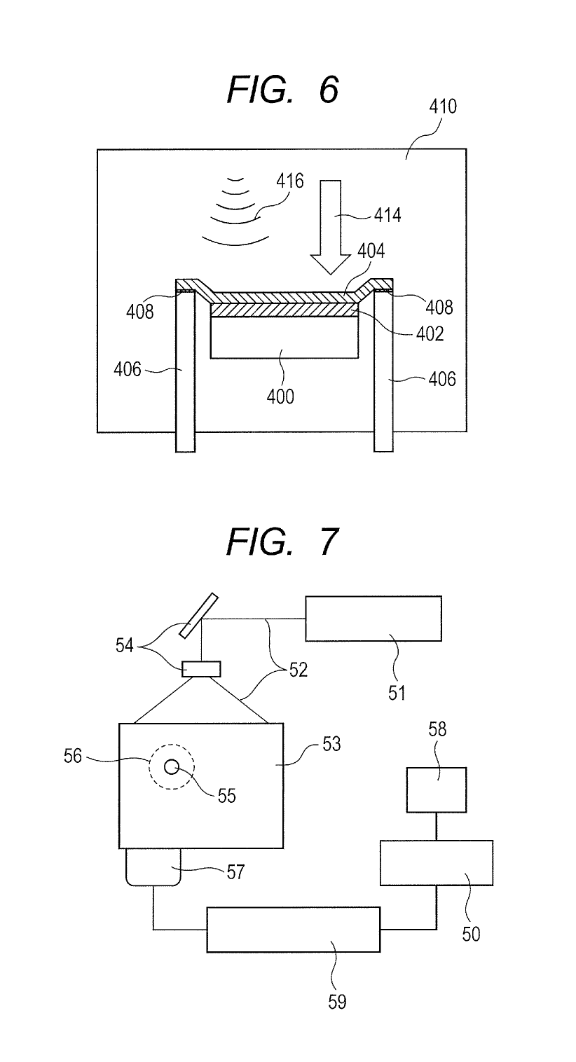

Next, an example of a photoacoustic probe according to the present invention will be described. FIG. 6 is a schematic diagram of the photoacoustic probe. The probe includes: a device substrate 400 including a CMUT (Capacitive Micromachined Ultrasonic Transducer) as an ultrasonic sensor; an acoustic impedance matching layer 402 having functions of protecting the CMUT and transmitting ultrasonic wave 416; and an optical reflection member 404 for reflecting a laser beam 414 at a high reflectance. These components are accommodated in a case 406. The case 406 and the optical reflection member 404 are sealed to each other with adhesive 408, which prevents an acoustic medium 410 from entering the case 406.

The capacitive electromechanical transducer included in the probe of the embodiment of the present invention will be described. FIGS. 4A and 4B illustrate an example of the probe using a CMUT including an element having a plurality of cells. FIG. 4A is a top plan view. FIG. 4B is a sectional view of FIG. 4A taken along line B-B. The probe includes a plurality of elements 8 including cells 7. In FIGS. 4A and 4B, each of four elements 8 includes nine cells 7. However, only if at least one cell is included in each element 8, the number of cells is arbitrary.

As illustrated in FIG. 4B, a cell 7 in this embodiment includes a substrate 1, a first electrode 2, an insulating film 3 on the first electrode 2, a vibration film 4 provided on the insulating film 3 via a space 5 (cavity), and a second electrode 6 on the vibration film 4. The substrate 1 is made of Si. Instead, this substrate may be an insulating substrate made of glass. The first electrode 2 is a metal thin film made of any of titanium and aluminum. In the case where the substrate 1 is made of silicon with a low resistance, the substrate itself can serve as the first electrode 2. The insulating film 3 can be formed by stacking a thin film made of silicon oxide. A vibration film 4 and a vibration film supporter 9 supporting the vibration film 4 is formed by stacking a thin film made of silicon nitride. The second electrode 6 can be formed of a metal thin film made of any of titanium and aluminum. In this specification, the vibration film at a membrane part made of one of a silicon nitride film and a single crystal silicon film, and the second electrode may be collectively called the vibration film.

The probe of this embodiment can be formed using the method of manufacturing a bonding type. A cell 7 having the bonding type configuration illustrated in FIG. 5 includes a vibration film 4 provided on a silicon substrate 1 via a space 5, a vibration film supporter 9 supporting the vibration film in a manner allowing this film to vibrate, and a second electrode 6. Here, the silicon substrate 1 having a low resistance also serves as the first electrode. Instead, the substrate may be an insulating glass substrate. In this case, a metal thin film (one of titanium and aluminum) to serve as the first electrode 2 is formed on the substrate 1. The vibration film 4 is formed of a junction silicon substrate. Here, the vibration film supporter 9 is made of silicon oxide. Instead, this supporter may be formed by stacking a thin film made of silicon nitride. The second electrode 6 is formed of a metal thin film made of aluminum. FIGS. 4 and 5 illustrate an acoustic impedance matching layer 10, and optical reflection member 11 including a warp suppressing layer.

A principle of driving the probe of this embodiment will be described. The cell is formed of the first electrode 2 and the vibration film that interpose the space 5. Accordingly, to receive acoustic waves, a direct current voltage is applied to one of the first electrode 2 and the second electrode 6. When the acoustic waves are received, the acoustic waves vibrate the vibration film to change the distance (height) of the space. Accordingly, the capacitance between the electrodes is changed. The change in capacitance is detected from one of the first electrode 2 and the second electrode 6, thereby allowing the acoustic waves to be detected. The element can also transmit acoustic waves by applying an alternating voltage to one of the first electrode 2 and the second electrode 6 to vibrate the vibration film.

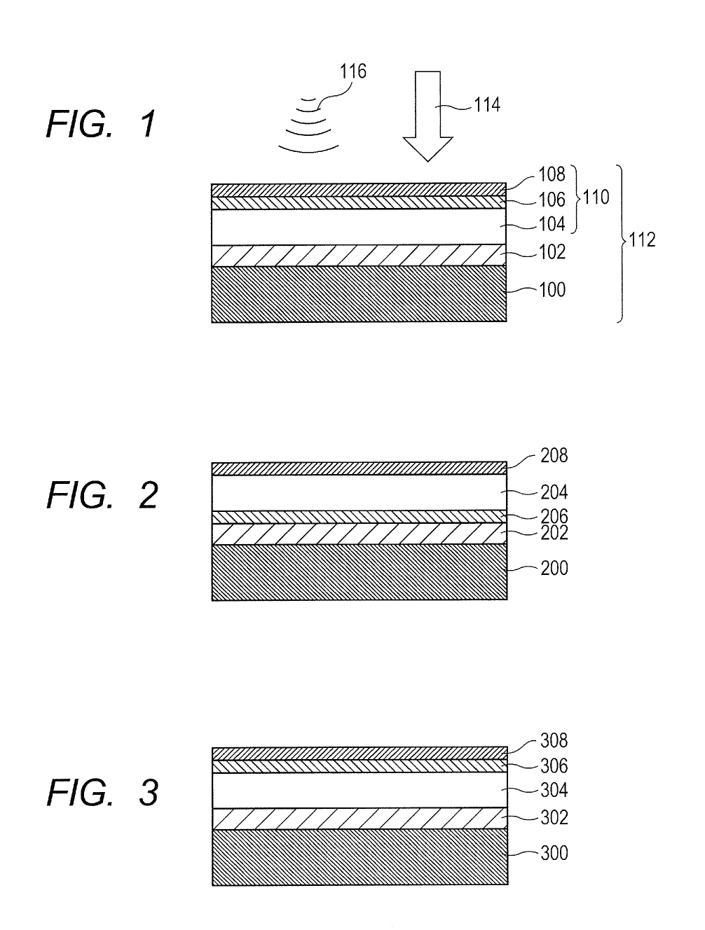

Referring to FIG. 1, the layer configuration on the capacitive electromechanical transducer, which characterizes the present invention, will be further described in detail. FIG. 1 is a sectional view illustrating the photoacoustic probe of this embodiment. FIG. 1 illustrates a substrate (CMUT substrate) 100 including a CMUT element, an acoustic impedance matching layer 102 formed between the CMUT substrate 100 and a support layer 104, a warp suppressing layer 106, an optical reflection layer 108, and an optical reflection member 110 including the support layer 104, the warp suppressing layer 106 and the optical reflection layer 108. The CMUT substrate 100, the acoustic impedance matching layer 102 and the optical reflection member 110 configure a photoacoustic probe 112.

For instance, the CMUT substrate 100 includes a membrane made of one of Si and SiN on a cavity formed on an Si substrate. The acoustic impedance matching layer 102 is formed on an element 8 of the CMUT substrate 100 (specifically, on the vibration film including the membrane), and has a function of protecting the membrane, and a function of efficiently transmitting ultrasonic wave 116 from the optical reflection member 110 to the CMUT substrate 100. The acoustic impedance matching layer 102 can suitably be made of what has a low Young's modulus that does not largely change mechanical characteristics, such as the spring constant of the membrane. More specifically, a suitable Young's modulus is 50 MPa or less. The Young's modulus of 50 MPa or less alleviates adverse effects on the vibration film due to the stress of optical reflection layer 11. Since the stiffness (Young's modulus) is sufficiently low, the substantial mechanical property of the vibration film 4 is not changed. Furthermore, the acoustic impedance matching layer 102 is suitably made of material having an acoustic impedance equivalent to that of the membrane. More specifically, the suitable acoustic impedance ranges from 1 MRayls to 2 MRayls, inclusive (1 MRayls=1×10⁶ kg·m⁻²·s⁻¹). For instance, such an acoustic impedance matching layer may be made of polydimethylsiloxane (PDMS). Furthermore, any of PDMS to which silica particles are added, fluorosilicone in which part of hydrogens of PDMS are replaced with fluorines, and fluorosilicone to which silica particles are added can be adopted. Addition of silica particles is adjusted to efficiently transmit ultrasonic wave.

The optical reflection layer 108 is for reflecting a laser beam 114, and provided closer to an object than the element 8 is. More specifically, this layer reflects light emitted on the object and the scattered light. Especially in the case of diagnosing a living body, a near-infrared region of wavelengths from 700 to 1000 nm is often used as the laser beam 114. The optical reflection layer 108 can use a metal film having a high reflectance (suitably, 80% and more, and more suitably 90% and more) in the wavelength region (e.g., 700 to 1000 nm) to be used. For example, a film of one of Au, Ag and Al can suitably be used.

The suitable film thickness of the optical reflection layer 108 can be equal to or less than 1/30 of the wavelength of acoustic waves. More specifically, the thickness can be equal to or less than 10 μm in consideration of acoustic impedance. For instance, Au has a high acoustic impedance of about 63×10⁶ [kg·m⁻²·s⁻¹] (=63 MRayls). Accordingly, to prevent reflection of ultrasonic wave due to acoustic impedance inconsistency, the thickness is required to be sufficiently small. The suitable thickness of Au is equal to or less than 10 μm. In actuality, in consideration of cost, the suitable thickness is between 0.1 and 1 μm, inclusive. Moreover, a dielectric multilayer film is formed on the metal film made of Au can be formed thereby allowing the reflectance to be further improved. The optical reflection layer may be a dielectric multilayer film.

The support layer 104 is a layer for supporting such an optical reflection layer 108, and provided closer to the element 8 than the optical reflection layer 108 is. The optical reflection layer 108 can be formed directly on the acoustic impedance matching layer 102. However, this reflection layer can suitably be formed on the support layer 104. The acoustic impedance matching layer 102 is made of material having a low Young's modulus. Accordingly, in the case of forming the optical reflection layer 108 directly on the acoustic impedance matching layer, there is a possibility that the stress from the optical reflection layer deforms the acoustic impedance matching layer. The acoustic impedance matching layer 102 is made of material having a low Young's modulus. It is therefore difficult to reduce the surface roughness. Furthermore, it is difficult to increase the reflectance of the optical reflection layer on the acoustic impedance matching layer. Thus, the optical reflection layer 108 can be suitably formed on the support layer 104 having a higher stiffness than the acoustic impedance matching layer 102. More specifically, the acoustic impedance of the support layer 104 can be between 1 and 5 MRayls, inclusive. The Young's modulus of the support layer 104 is larger than that of the acoustic impedance matching layer 102, and more specifically, between 100 MPa and 20 GPa, inclusive. The acoustic impedance of the support layer 104 is configured close to the value of the acoustic impedance of the acoustic impedance matching layer 102, thereby allowing the amount of reflection of acoustic waves to be reduced at the interface between the support layer 104 and the acoustic impedance matching layer 102. Material suitable for support layer 104 is material that has an acoustic impedance equivalent to that of the acoustic medium and a favorable ultrasound transparency. For instance, olefin resin can be suitably adopted. Among olefin resins, polymethylpentene resin can be suitably adopted. In consideration of forming the optical reflection layer and adhesion to the CMUT substrate 100, appropriate flexibility of support layer 104 is suitable. What have a thickness of about 10 to 150 μm can suitably be used.

The warp suppressing layer 106 is a layer provided for suppressing the warp of the support layer 104 and suppresses the warp of the support layer in the case of forming the optical reflection layer on the support layer, i.e., the Young's modulus of the warp suppressing layer 106 is more than the Young's modulus of the support layer 104. Meanwhile, the warp suppressing layer 106 has a sufficiently small thickness with respect to the wavelength of ultrasonic wave to achieve a favorable ultrasound transparency. More specifically, the suitable thickness of the warp suppressing layer 106 is equal to or less than 100 μm. However, in the case of using material having a high acoustic impedance, the suitable thickness is equal to or less than 10 μm. The more suitable thickness is equal to or less than 1 μm. The suitable Young's modulus of the warp suppressing layer 106 is equal to or more than 100 MPa. The more suitable Young's modulus is equal to or more than 1 GPa. The further suitable Young's modulus is equal to or more than 20 GPa. To achieve the feature, hard material that is any of inorganic materials, such as SiO₂ (silicon oxide), Al₂O₂ (aluminum oxide), TiO₂, ZnO, TiN, SiN and AlN, can be suitably adopted. For instance, the thin film includes at least any of silicon oxide and aluminum oxide. Furthermore, for instance, silicon oxide can be formed into a film by one of a CVD method and a sputtering method. The warp suppressing layer suppresses the warp of the optical reflection member owing to the stiffness. The warp suppressing layer can be disposed between the optical reflection layer and the support layer (i.e., the surface of the support layer facing the optical reflection layer). Instead, the warp suppressing layer can be disposed on the surface of the support layer other than that facing the optical reflection layer (i.e., the surface of the support layer facing the element).

Furthermore, the warp suppressing layers can be suitably disposed symmetrically with respect to the support layer. In a certain optical reflection member, the warp suppressing layers can be disposed on both the surfaces of the support layer, and the optical reflection layer can be provided. In another optical reflection member, the warp suppressing layers are disposed on both the surfaces of the support layer, and the optical reflection layer can be stacked thereon.

Examples of the present invention will hereinafter be described.

### EXAMPLE 1

FIG. 3 is a sectional view of a photoacoustics probe of Example 1. As illustrated in FIG. 3, a warp suppressing layer 306 is film-formed on a support layer 304 made of polymethylpentene resin of 20 mm long, 20 mm wide and 100 μm thick. The warp suppressing layer of 200 nm of SiO₂ is formed by a sputtering method. Next, Au (with a thickness of 200 nm) is formed as the optical reflection layer 308 on the warp suppressing layer 306 by a vacuum deposition method. A sputtering method can be used as a method of forming Au. The method is appropriately selected according to the relationship in the direction of stress with SiO₂.

Next, an oxygen plasma process is applied to the undersurface of the support layer 304. Subsequently, fluorosilicone resin (made by Shin-Etsu Silicone) is applied into a thickness of 50 μm as the acoustic impedance matching layer 302 by a printing method. The CMUT substrate 300 is stacked thereon, and thermoset at 125° C., thereby allowing the acoustic impedance matching layer 302 and the CMUT substrate to adhere to each other and allowing the acoustic impedance matching layer 302 and the support layer to adhere to each other. The warp of the thus formed optical reflection member is suppressed in comparison with the case without the warp suppressing layer. After adhesion, the optical reflection member does not exfoliate.

### EXAMPLE 2

FIG. 2 is a diagram illustrating another example of the present invention. As illustrated in FIG. 2, a warp suppressing layer 206 is film-formed on the undersurface of a support layer 204 made of polymethylpentene resin of 20 mm long, 20 mm wide and 100 μm thick. 200 nm of Al₂O₂ is formed as the warp suppressing layer by an EB deposition method. Next, Au (with a thickness of 200 nm) is formed as the optical reflection layer 208 on the upper surface of the support layer 204 by a vacuum deposition method. Next, fluorosilicone resin (made by Shin-Etsu Silicone) is applied into a thickness of 50 μm as the acoustic impedance matching layer 202 on the undersurface of the warp suppressing layer 206 by a printing method, subsequently thermoset at 125° C., and then caused to adhere onto the CMUT substrate 200 as illustrated in FIG. 2. This example can exert advantageous effects equivalent to those of Example 1.

### EXAMPLE 3

Example 3 will be described. According to this example, in the configuration in FIG. 3, the warp suppressing layer is also provided between the support layer 304 and the acoustic impedance matching layer 302. That is, the warp suppressing layers 306 (the undersurface is not illustrated) are formed on both the surfaces of the support layer 304 made of polyethylene resin of 20 mm long, 20 mm wide and 100 μm thick. An SiN film is formed into a thickness of 100 nm as the warp suppressing layer 306 by a sputtering method. Next, an Ag film (with a thickness of 200 nm) is formed on one surface of the warp suppressing layer 306 by a vacuum deposition method. Fluorosilicone resin (made by Shin-Etsu Silicone) is applied into a thickness of 50 μm as a acoustic impedance matching layer 302 by a printing method on the other surface of the warp suppressing layer 306, stacked on the CMUT substrate 300, and thermoset to adhere thereto. The warp of the thus formed optical reflection member is also suppressed in comparison with the case without the warp suppressing layer. After adhesion, the optical reflection member does not exfoliate.

### EXAMPLE 4

The probe including the electromechanical transducer described in the embodiments and the examples is applicable to an object information acquisition apparatus using acoustic waves. Acoustic waves from an object are received by the electromechanical transducer. Through use of an output electric signal, object information in which an optical property value of the object, such as the optical absorption coefficient, is reflected can be acquired.

FIG. 7 illustrates an object information acquisition apparatus using photoacoustic effects according to this example. An object 53 is irradiated with pulsed light 52 emitted from a light source 51 via optical elements 54, such as a lens, a mirror and an optical fiber. A light absorber 55 in the object 53 absorbs the energy of the pulsed light and generates photoacoustic waves 56, which are acoustic waves. A probe 57 including a casing for accommodating an electromechanical transducer receives the photoacoustic waves 56, converts the waves into an electric signal and outputs the signal to a signal processor 59. The signal processor 59 performs a signal process, such as A/D conversion and amplification, on the input signal, and outputs the signal to a data processor 50. The data processor 50 acquires object information (object information in which an optical property value of the object, such as an optical absorption coefficient is reflected) as an image data, using the input signal. The display 58 displays an image based on the image data input from the data processor 50. The probe may be any of a type of being mechanically scanned and a type (hand-held type) of being moved by a user, such as any of a doctor and a technician, with respect to an object.

The probe of the present invention includes a warp suppressing layer, such as a thin film layer made of inorganic material that suppresses the warp of the optical reflection member on the receiving surface of the capacitive electromechanical transducer. Accordingly, exfoliation of the optical reflection member due to the warp of this optical reflection member can be suppressed. In the case where a acoustic impedance matching layer is provided on a receiving surface, variation in thickness of the protection film caused by the warp of the acoustic impedance matching layer of the optical reflection member can be reduced. This reduction allows the probe including the optical reflection member to stably receive acoustic waves.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-083419, filed Mar. 31, 2012, and Japanese Patent Application No. 2013-040133, filed Feb. 28, 2013, which are hereby incorporated by reference herein in their entirety.

What is claimed is:

1. A probe receiving an acoustic wave from an object, comprising:
an element having at least one cell in which a vibration film containing one electrode out of two electrodes that are provided so as to interpose a space therebetween is vibratably owing to the acoustic wave,;
an optical reflection layer that is provided closer to the object than the element is;
a support layer that is provided closer to the element than the optical reflection layer is, and supports the optical reflection layer; and
a warp suppressing layer to suppress the warp of the support layer, that is provided on at least one of a surface of the support layer closer to the optical reflection layer and a surface of the support layer closer to the element.

2. The probe according to claim 1, wherein the warp suppressing layer has a Young's modulus of at least 100 MPa.

3. The probe according to claim 1, wherein the warp suppressing layer has a thickness equal to or less than 100 μm.

4. The probe according to claim 1, wherein the warp suppressing layer is made of inorganic material.

5. The probe according to claim 4, wherein the warp suppressing layer is an SiO₂ film.

6. The probe according to claim 1, further comprising an acoustic impedance matching layer between the element and the support layer.

7. The probe according to claim 6, wherein the acoustic impedance matching layer has an acoustic impedance between 1 and 2 MRayls, inclusive.

8. The probe according to claim 1,
wherein the element receives an acoustic wave caused by irradiation with light on the object, and
the optical reflection layer has an optical reflectance of at least 80% in a wavelength region of the light.

9. The probe according to claim 1, wherein the support layer has an acoustic impedance between 1 and 5 MRayls, inclusive.

10. The probe according to claim 6, wherein the support layer has a higher Young's modulus than the acoustic impedance matching layer and has a lower Young's modulus than the warp suppressing layer.

11. A probe receiving an acoustic wave from an object, comprising:
an element having at least one cell in which a vibration film containing one electrode out of two electrodes that are provided so as to interpose a space therebetween is supported in a manner owing to the acoustic wave;
an optical reflection layer that is provided closer to the object than the element is;
a support layer that is provided closer to the element than the optical reflection layer is, and supports the optical reflection layer; and
a layer that is provided on at least one of a surface of the support layer closer to the optical reflection layer and a surface of the support layer closer to the element and has a higher Young's modulus than the support layer has.

12. The probe according to claim 11, wherein the layer that has a higher Young's modulus than support layer has a Young's modulus equal to or less than 100 MPa.

13. The probe according to claim 11, wherein the layer that has the higher Young's modulus than the support layer has has a thickness equal to or less than 100 μm.

14. The probe according to claim 11, wherein the layer that has the higher Young's modulus than the support layer has is made of inorganic material.

15. The probe according to claim 14, wherein the layer that has the higher Young's modulus than the support layer has is an SiO₂ film.

16. The probe according to claim 11, further comprising an acoustic impedance matching layer between the element and the support layer.

17. The probe according to claim 16, wherein the acoustic impedance matching layer has an acoustic impedance between 1 and 2 MRayls, inclusive.

18. The probe according to claim 11,
wherein the element receives an acoustic wave caused by irradiation with light on the object, and
the optical reflection layer has an optical reflectance of at least 80% in a wavelength region of the light.

19. The probe according to claim 11, wherein the support layer has an acoustic impedance between 1 and 5 MRayls, inclusive.

20. An object information acquisition apparatus, comprising: the probe according to claim 1; a light source;
and a data processing device, wherein the probe receives an acoustic wave caused by irradiation on the object with light emitted from the light source and converts the wave into an electric signal, and
the data processing device acquires information on the object using the electric signal.
